(19) United States
(12) Patent Application Publication
(10) Pub. No.: US 2013/0250586 A1
(43) Pub. Date: Sep. 26, 2013

(54) Lighting Device

(71) Applicant: TOSHIBA LIGHTING & TECHNOLOGY CORPORATION, Yokosuka-shi (JP)

(72) Inventors: Jun Sasaki, Yokosuka-shi (JP); Ryotaro Matsuda, Yokosuka-shi (JP); Naoto Mori, Yokosuka-shi (JP); Yoshiyuki Matsunaga, Yokosuka-shi (JP); Shigehisa Kawatsuru, Yokosuka-shi (JP); Takahiro Sogo, Yokohama-shi (JP)

(73) Assignee: TOSHIBA LIGHTING & TECHNOLOGY CORPORATION, Yokosuka-shi (JP)

(21) Appl. No.: 13/800,315

(22) Filed: Mar. 13, 2013

(30) Foreign Application Priority Data
Mar. 26, 2012 (JP) 2012-070022

(51) Int. Cl. F21V 29/00

(52) U.S. Cl. CPC F21V 29/004
USPC 362/373

(57) ABSTRACT

A lighting device according to an embodiment includes a light source module, a thermal radiation member, and a fixing member. The light source module is a module mounted with a light-emitting element such as an LED (Light Emitting Diode) on the inside and including the light-emitting element as a light source. In the thermal radiation member, the light source module is set. The thermal radiation member radiates heat generated from the light source module. A fixing member is screwed on a sidewall of the thermal radiation member in a state in which the fixing member surrounds the light source module and the thermal radiation member.

### CROSS-REFERENCE TO RELATED APPLICATION

This application is based upon and claims the benefit of priority from Japanese Patent Application No. 2012-070022 file on Mar. 26, 2012, the entire contents of which are incorporated herein by reference.

### FIELD

Embodiments described herein relate generally to a lighting device.

### BACKGROUND

A lighting device including a semiconductor light-emitting element such as an LED (Light Emitting Diode) as a light source has been used. For example, an LED module mounted with the LED is rotated, whereby the lighting device is attached to a socket. In general, a heat conduction sheet or the like is stuck to the LED module. If the lighting device is attached to the socket, the LED module is brought into contact with a thermal radiation member. The lighting device is considered to facilitate replacement of the LED module. However, since the LED module is rotated to be attached and detached, in some cases, the heat conduction sheet is peeled by friction during the rotation, causing deterioration in a thermal radiation effect.

### DESCRIPTION OF THE DRAWINGS

FIG. 1 is a perspective view illustrating an example of an external appearance of a lighting device according to a first embodiment;

FIG. 2 is a perspective view illustrating an example of the lighting device in a disassembled state;

FIG. 3 is a perspective view of an example of the lighting device in a disassembled state;

FIG. 4 is a perspective view of an example of the lighting device in a disassembled state;

FIG. 5 is a diagram schematically illustrating an enlarged view of a fixing side screwing section according to the first embodiment;

FIG. 6 is a perspective view illustrating an example of a light source module in a disassembled state according to the first embodiment;

FIG. 7 is a longitudinal sectional view illustrating the lighting device;

FIG. 8 is a front view illustrating a thermal radiation module according to the first embodiment;

FIG. 9 is an explanatory diagram for explaining an electrode according to a second embodiment;

FIG. 10 is an explanatory diagram for explaining the electrode; and

FIG. 11 is an explanatory diagram for explaining a ring member according to the second embodiment.

### DETAILED DESCRIPTION

A lighting device 1 according to an embodiment explained below includes a thermal radiation module 100, 500 functioning as a thermal radiation member in which a light source module 300, 400 mounted with a light-emitting element is set, the thermal radiation module 100, 500 radiating heat generated from the light source module 300, 400; and a fixing member 200 screwed on a sidewall 103 of the thermal radiation module 100, 500 in a state in which the fixing member 200 surrounds the light source module 300, 400 and the thermal radiation module 100, 500.

In the lighting device 1 according to the embodiment, the fixing member 200 includes a pressing section configured to press the light source module 300, 400 in a direction toward the thermal radiation module 100, 500 if the fixing member 200 is screwed on the sidewall 103 of the thermal radiation module 100, 500.

In the lighting device 1 according to the embodiment, the fixing member 200 includes a bottom wall 210a as the pressing section. If the fixing member 200 is screwed on the sidewall 103 of the thermal radiation module 100, 500, the fixing member 200 adjusts, with a cylindrical reflecting section 220 formed from an opening section of the bottom wall 210a in a direction away from the light source module 300, 400, a reflecting direction of light emitted by the light-emitting element mounted on the light source module 300, 400.

In the lighting device 1 according to the embodiment, the thermal radiation module 100, 500 includes, on a setting surface 101, 501 on which the light source module 300, 400 is set, locking sections 131 and 132 locked to the light source module 300, 400. The light source module 300, 400 is set in the thermal radiation module 100, 500 in a state in which the light source module 300, 400 is locked to the locking sections 131 and 132.

In the lighting device 1 according to the embodiment, the locking sections 131 and 132 of the thermal radiation module 100, 500 are formed in a shape projecting from the setting surface 101, 501. In the light source module 300, 400, cutout sections 303 and 304 for locking the locking sections 131 and 132 are formed in positions opposed to the locking sections 131 and 132 in a first surface 301, 401 set on the setting surface 101, 501 of the thermal radiation module 100, 500.

In the lighting device 1 according to the embodiment, in the fixing member 200, slits 211 and 212 are formed such that fixing side screwing sections 213 and 214 screwed on the sidewall 103 of the thermal radiation module 100, 500 are elastically deformable in an outer side direction. Projecting sections 213a and 214a projecting from the inner surfaces of the fixing side screwing sections 213 and 214 to the inner side are formed. In the thermal radiation module 100, 500, projecting sections 121a and 122a projecting from heat radiation side screwing sections 121 and 122, which form the sidewall 103, screwed with the fixing side screwing sections 213 and 214 to the outer side are formed.

In the lighting device 1 according to the embodiment, the thermal radiation side screwing sections 121 and 122 of the thermal radiation module 100, 500 are formed in a spiral shape for enabling fixing member 200 to move in a direction toward the thermal radiation module 100, 500.

In the lighting device 1 according to the embodiment, the light source module 300, 400 includes electrodes 311, 312, 411, and 412 for supplying electric power to the light-emitting element. The thermal radiation module 100, 500 includes, in positions opposed to the electrodes 311, 312, 411, and 412 in the setting surface 101, 501 on which the light source module 300, 400 is set, electrodes 141, 142, 511, and 512 that electrically come into contact with the electrodes 311, 312, 411, and 412.

In the lighting device 1 according to the embodiment, the electrodes 411 and 412 are a plurality of semiarcuate electrodes respectively provided on different concentric circles on the surface 401 of the light source module 400 set on the setting surface 501 of the thermal radiation module 500. The electrodes 511 and 512 are a plurality of circular electrodes provided in positions opposed to the electrodes 411 and 412 in the setting surface 501 of the thermal radiation module 500.

The lighting device 1 according to the embodiment further includes a ring member 380 set on a side surface of the light source module 300, 400 and configured to come into contact with the inner wall of the fixing member 200.

### First Embodiment

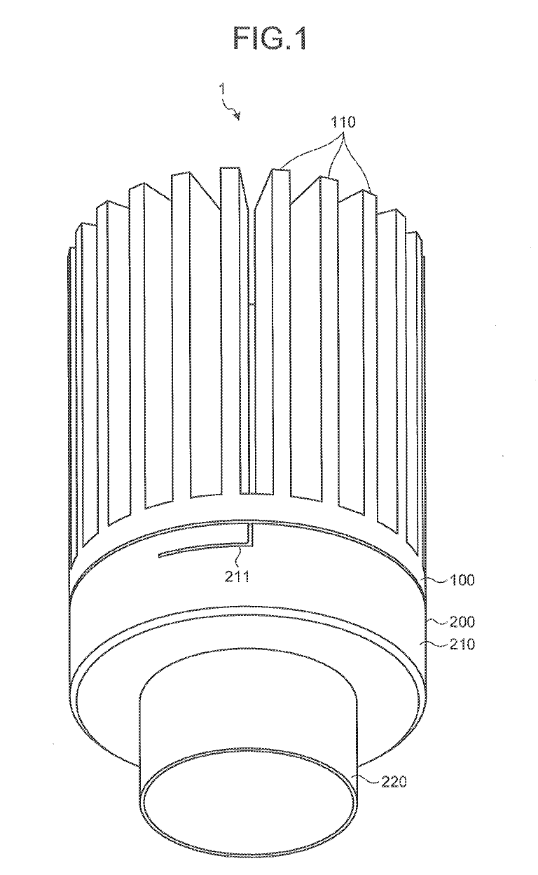

FIG. 1 is a perspective view illustrating an example of an external appearance of the lighting device 1 according to a first embodiment. In FIG. 1, an example of the lighting device 1 seen from an oblique lower direction is illustrated. The lighting device 1 illustrated in FIG. 1 is, for example, a lighting device of a downlight type embedded and set in the indoor ceiling. The lighting device 1 illuminates, for example, the inside of a room located in a downward direction illustrated in FIG. 1 by causing a light-emitting element such as an LED mounted on the inside to emit light. The lighting device 1 includes a thermal radiation module 100 and a fixing member 200.

The thermal radiation module 100 is made of metal having higher heat conductivity and is, for example, a radiation member molded by aluminum die cast. In the thermal radiation module 100, thermal radiation fins 110 are vertically provided. The thermal radiation fins 110 emit heat generated from the light-emitting element mounted on the inside of the lighting device 1 to the outside. In the figures referred to below, a part of the thermal radiation fins are sometimes denoted by sign 110. However, members having a plane shape vertically provided in the thermal radiation module 100 correspond to the thermal radiation fins 110. A part of the thermal radiation module 100 is embedded in the ceiling in the room. For example, in the thermal radiation module 100, the thermal radiation fins 110 are embedded in the ceiling and a lower end region other than the thermal radiation fins 110 is exposed to the room.

The fixing member 200 is made of, for example, synthetic resin having light resistance, heat resistance, and electric insulation. The fixing member 200 includes a fixing section 210 and a reflecting section 220. The fixing section 210 is screwed on the sidewall of the thermal radiation module 100. Specifically, a slit 211 is formed in the fixing section 210. The slit 211 is screwed on the sidewall of the thermal radiation module 100, whereby the fixing member 200 is attached to the thermal radiation module 100.

The reflecting section 220 is formed in a cylindrical shape opened at both the upper and lower ends. The reflecting section 220 adjusts a luminous intensity distribution direction of light emitted from the light-emitting element mounted on the inside of the lighting device 1.

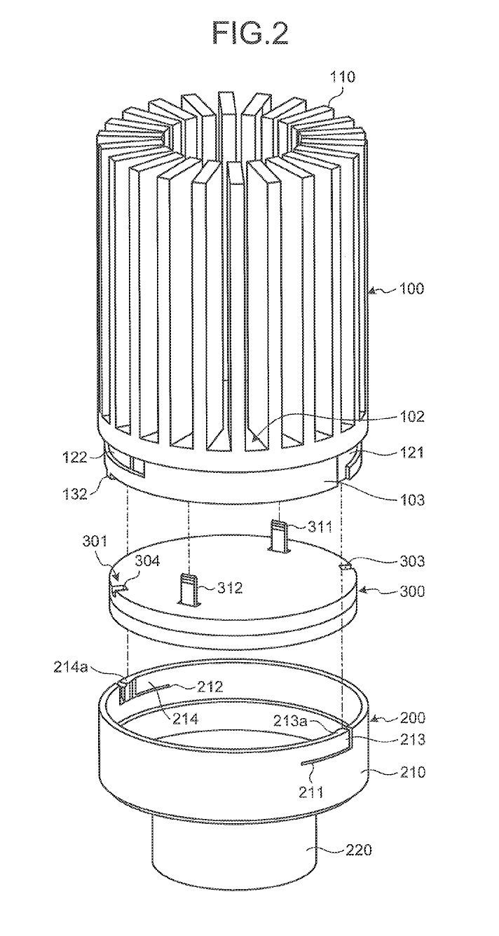

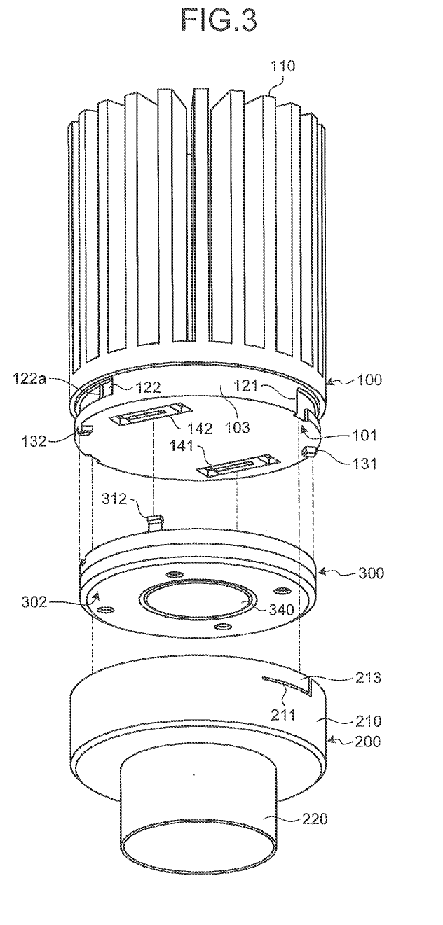

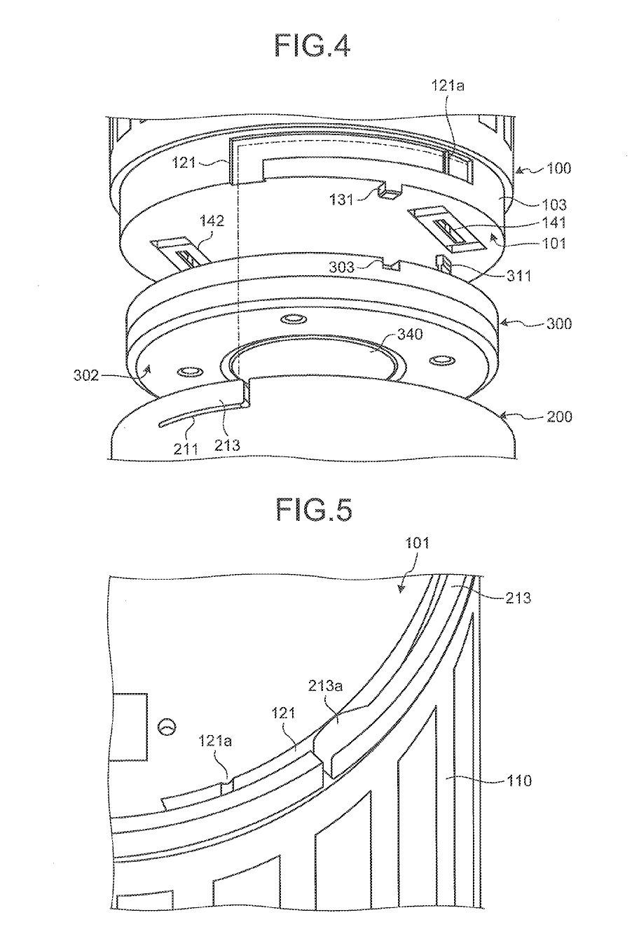

An example of the lighting device 1 in a disassembled state according to the first embodiment is explained. FIGS. 2 to 4 are perspective views illustrating examples of the lighting device 1 in a disassembled state according to the first embodiment. In FIG. 2, an example in which the lighting device 1 is viewed from an oblique upper direction is illustrated. In FIG. 3, an example in which the lighting device 1 is viewed from an oblique lower direction is illustrated. In FIG. 4, an enlarged view of the lighting device 1 viewed from the oblique lower direction is illustrated.

As illustrated in FIGS. 2 and 3, the lighting device 1 includes a light source module 300 besides the thermal radiation module 100 and the fixing member 200 illustrated in FIG. 1. As illustrated in FIG. 3, the thermal radiation module 100 is formed in a columnar shape and includes a substantially circular setting surface 101 on which the light source module 300 is set. As illustrated in FIG. 2, the thermal radiation fins 110 are vertically provided on a substantially circular fin surface 102, which is the rear surface of the setting surface 101.

In the thermal radiation module 100, thermal radiation side screwing sections 121 and 122 for screwing with the fixing member 200 are formed on the sidewall 103 between the setting surface 101 and the fin surface 102. The thermal radiation side screwing sections 121 and 122 are formed in a concave shape formed by shaving the sidewall 103 in a substantially spiral shape.

As illustrated in FIG. 3, in the thermal radiation module 100, locking sections 131 and 132 projecting from the setting surface 101 are formed. The locking sections 131 and 132 are formed at the circumferential edge portion of the setting surface 101 and locked to the light source module 300 to play a role of preventing the light source module 300 from rotating.

In the thermal radiation module 100, electrodes 141 and 142 are provided on the setting surface 101. The electrodes 141 and 142 are electrodes on a receiving side of an attachment plug. Electrodes 311 and 312 of the light source module 300 explained below are inserted into the electrodes 141 and 142. For example, one electrode 141 of the electrodes 141 and 142 is an anode and the other electrode 142 is a cathode.

The light source module 300 is mounted with a light-emitting element such as an LED on the inside. The light source module 300 includes, as illustrated in FIGS. 2 and 3, a substantially circular first surface 301 set on the setting surface 101 of the thermal radiation module 100 and a substantially circular second surface 302, which is the rear surface of the first surface 301.

In the light source module 300, concave cutout sections 303 and 304 formed by cutting out a part of the circumferential edge portion of the first surface 301 are formed. The cutout section 303 locks the locking section 131 of the thermal radiation module 100. The cutout section 304 locks the locking section 132 of the thermal radiation module 100. In this way, the cutout sections 303 and 304 lock the locking sections 131 and 132 to prevent the light source module 300 from rotating.

In the light source module 300, the electrodes 311 and 312 are provided on the first surface 301. The electrodes 311 and 312 are electrodes on an inserting side of the attachment plug. The electrodes 311 and 312 are arranged in a positional relation same as a positional relation between the electrodes 141 and 142 of the thermal radiation module 100 and inserted into the electrodes 141 and 142. For example, one electrode 311 of the electrodes 311 and 312 is an anode and the other electrode 312 is a cathode.

If the light source module 300 is inserted into the thermal radiation module 100, the cutout sections 303 and 304 are formed on the first surface 301 of the light source module 300 and the locking sections 131 and 132 are formed on the setting surface 101 of the thermal radiation module 100 such that the cutout sections 303 and 304 are located in positions opposed to the locking sections 131 and 132.

The thermal radiation module 100 is connected to a power supply device to which electric power is supplied from a not-illustrated commercial alternating-current power supply. If the electrode 311 is inserted into the electrode 141 and the electrode 312 is inserted into the electrode 142, the thermal radiation module 100 supplies the electric power from the commercial alternating-current power supply to the light source module 300. Consequently, the light source module 300 can cause the light-emitting element mounted on the inside to emit light.

The light-emitting element mounted on the light source module 300 is sometimes heated to have high temperature if the light-emitting element emits light. The performance of the light-emitting element is deteriorated if the light-emitting element has high temperature. Therefore, a not-illustrated heat conduction sheet is stuck to the first surface 301 of the light source module 300. Consequently, the first surface 301 of the light source module 300 and the setting surface 101 of the thermal radiation module 100 come into close surface contact with each other. It is possible to efficiently transmit heat generated from the light source module 300 to the thermal radiation module 100. As a result, it is possible to efficiently radiate the heat.

As illustrated in FIG. 2, the fixing member 200 is formed by the fixing section 210 and the reflecting section 220 formed in a cylindrical shape. The fixing section 210 is opened in substantially circular shapes respectively at both the upper and lower ends. The upper end opening section of the fixing section 210 is formed in a shape larger than the outer circle in the sidewall 103 of the thermal radiation module 100 such that the fixing section 210 can be screwed on the sidewall 103 of the thermal radiation module 100.

The slits 211 and 212 are formed in positions opposed to each other on the edge of the upper end opening section of the fixing section 210. Specifically, as illustrated in FIG. 4, the slits 211 and 212 are formed by a notch extending in a lower end direction from the edge of the upper end opening section and a notch extending substantially in parallel to the edge of the upper end opening section. Consequently, in the sidewall of the fixing section 210, a region surrounded by the slit 211 is formed as the fixing side screwing section 213 and a region surrounded by the slit 212 is formed as the fixing side screwing section 214. The fixing side screwing sections 213 and 214 are elastic members movable in the outer side direction of the fixing section 210 by the slit 211 and the slit 212. As illustrated in FIG. 2, in the fixing side screwing section 213, the projecting section 213a projecting in the inner side direction (the center direction of the upper end opening section) from the inner wall is formed. In the fixing side screwing section 214, the projecting section 214a is formed.

The fixing member 200 is screwed on the sidewall 103 of the thermal radiation module 100 in a state in which the fixing member 200 surrounds the light source module 300 and the thermal radiation module 100. Consequently, the fixing member 200 fixes the light source module 300 in a state in which the light source module 300 is held between the fixing member 200 and the setting surface 101 of the thermal radiation module 100.

A mechanism in which the light source module 300 and the fixing member 200 are attached to the thermal radiation module 100 is explained with reference to FIGS. 4 and 5. FIG. 5 is a diagram schematically illustrating an enlarged view of the fixing side screwing section 213 according to the first embodiment. In FIG. 5, an example in which the setting surface 101 is viewed from the lower direction in FIG. 4 is illustrated. In FIG. 5, the fixing side screwing section 213 of the fixing member 200 is mainly illustrated.

As illustrated in FIG. 4, the projecting section 121a projecting from the sidewall is formed in the thermal radiation side screwing section 121 of the thermal radiation module 100. Although not illustrated in FIG. 4, the projecting section 122a is formed in the thermal radiation side screwing section 122 as well (see FIG. 3). In the thermal radiation module 100, first, the electrodes 311 and 312 of the light source module 300 are inserted into the electrodes 141 and 142 of the thermal radiation module 100. Consequently, the light source module 300 is supported by the electrodes 141 and 142 to be attached to the thermal radiation module 100. That is, in the lighting device 1 according to the first embodiment, it is possible to provisionally set the light source module 300 in the thermal radiation module 100 without allowing the light source module 300 to drop. However, since the light source module 300 is supported by the electrodes 141 and 142 and the electrodes 311 and 312, the first surface 301 of the light source module 300 is not considered to be in close contact with the setting surface 101 of the thermal radiation module 100.

Subsequently, as illustrated in FIG. 4, the fixing side screwing section 213 of the fixing member 200 is slid to the thermal radiation side screwing section 121 of the thermal radiation module 100 in the vertical direction with respect to the setting surface 101. At this point, the fixing side screwing section 214 is also slid to the thermal radiation side screwing section 122.

Thereafter, as illustrated in FIGS. 4 and 5, the fixing member 200 is slid in a direction parallel to the setting surface 101. At this point, the projecting section 213a comes into contact with the projecting section 121a of the thermal radiation side screwing section 121. As explained above, since the slit 211 is formed in the fixing side screwing section 213, the fixing side screwing section 213 has a function of an elastic member movable in the outer side direction. Therefore, the projecting section 213a is pushed out in the outer side direction by the projecting section 121a and, when passing the projecting section 121a, returns to the original state to be locked to the projecting section 121a. Similarly, the projecting section 214a of the fixing side screwing section 214 is slid in the horizontal direction with respect to the setting surface 101 to be locked to the projecting section 122a. Consequently, the fixing member 200 is attached to the thermal radiation module 100 and fixes the light source module 300.

As explained above, in the lighting device 1 according to the first embodiment, the fixing member 200 is screwed on the sidewall 103 of the thermal radiation module 100 to fix the light source module 300 in a state in which the electrodes 311 and 312 of the light source module 300 are inserted into the electrodes 141 and 142 of the thermal radiation module 100. That is, in the lighting device 1 according to the first embodiment, the light source module 300 is inserted into the electrodes 141 and 142, which play a role of sockets, without rotating and is fixed by the fixing member 200. Therefore, the heat conduction sheet stuck to the light source module 300 is not peeled by friction or the like. As a result, in the lighting device 1 according to the first embodiment, it is possible to prevent the thermal radiation effect from being deteriorated.

As illustrated in FIGS. 2 to 4, the locking sections 131 and 132 of the thermal radiation module 100 are locked to the cutout sections 303 and 304 of the light source module 300. Therefore, in the lighting device 1 according to the first embodiment, even if the fixing member 200 sliding in the horizontal direction comes into contact with the light source module 300, the light source module 300 does not rotate. Therefore, in the lighting device 1 according to the first embodiment, it is possible to prevent peeling of the heat conduction sheet. Further, it is possible to prevent stress in the rotating direction of the light source module 300 from being applied to the electrodes 141 and 142 and the electrodes 311 and 312. That is, in the lighting device 1 according to the first embodiment, it is possible to not only prevent deterioration in the thermal radiation effect but also prevent the electrodes from being damaged.

As illustrated in FIGS. 4 and 5, the projecting sections 121a and 122a are formed in the thermal radiation module 100. The projecting sections 213a and 214a are formed in the fixing member 200. Consequently, the lighting device 1 according to the first embodiment can cause an operator, who attaches the fixing member 200 to the thermal radiation module 100, to feel as if the projecting sections 213a and 214a pass through the projecting sections 121a and 122a. Therefore, it is possible to inform the operator that the fixing member 200 is attached to the thermal radiation module 100.

The fixing member 200 attached to the thermal radiation module 100 presses the light source module 300 against the setting surface 101 of the thermal radiation module 100 to bring the first surface 301 of the light source module 300 and the setting surface 101 of the thermal radiation module 100 into close surface contact with each other. Therefore, the thermal radiation effect is improved. The improvement of the thermal radiation effect is explained below.

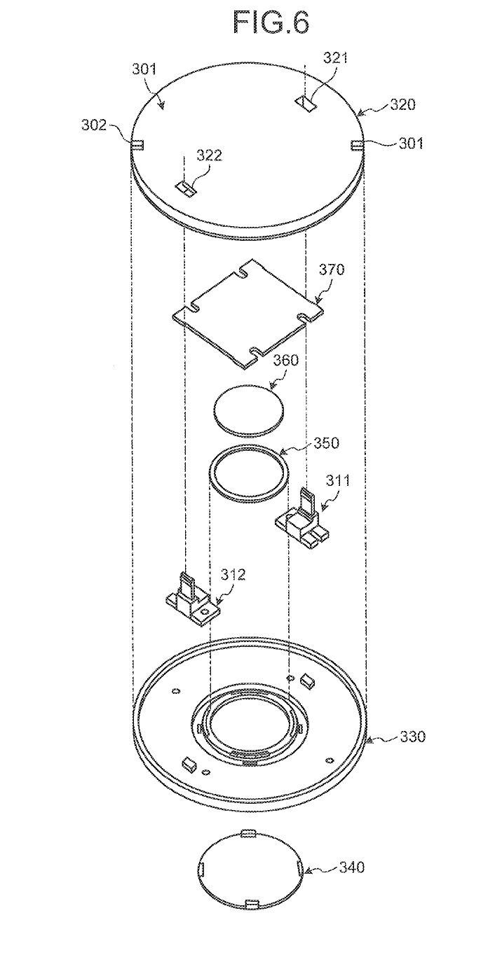

An example of the light source module 300 in a disassembled state according to the first embodiment is explained. FIG. 6 is a perspective view illustrating the example of the light source module 300 in a disassembled state according to the first embodiment. In FIG. 6, an example in which the light source module 300 is viewed from an oblique upper direction is illustrated.

As illustrated in FIG. 6, the light source module 300 includes electrodes 311 and 312, an upper housing 320, a lower housing 330, a lower surface cover 340, a frame 350, a silicon member 360, and a substrate 370.

The upper housing 320 is fixed to the lower housing 330. The electrodes 311 and 312, the frame 350, the silicon member 360, and the substrate 370 are held between the upper housing 320 and the lower housing 330. In the upper housing 320, through-holes 321 and 322 piercing through the upper and lower surfaces are formed. The distal ends of the electrodes 311 and 312 are inserted through the through-holes 321 and 322. The upper surface of the upper housing 320 corresponds to the first surface 301 of the light source module 300.

In the lower housing 330, openings sections opened at both the upper and lower ends are formed. The lower surface cover 340 is a transparent member. The lower surface cover 340 is attached to the lower surface of the lower housing 330 to cover the opening section formed in the lower housing 330. The frame 350 is mounted on the upper surface of the lower housing 330 to surround the opening section of the lower housing 330. The silicon member 360 is formed of transparent silicon and placed on the lower housing 330 to be surrounded by the frame 350. The silicon member 360 covers the opening section of the lower housing 330. The substrate 370 is mounted with a light-emitting element such as an LED to illuminate the lower direction in FIG. 6 from the opening section of the lower housing 330.

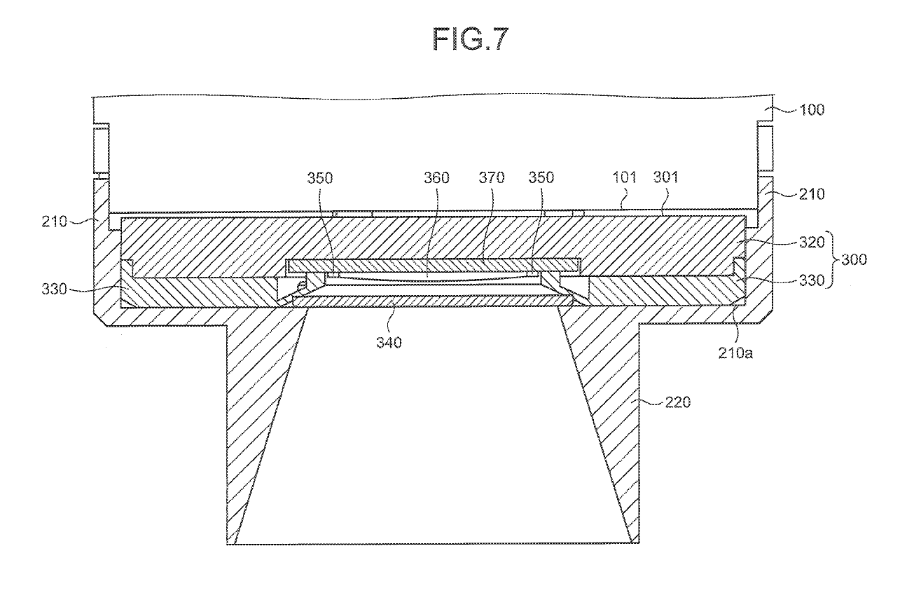

A cross section of the lighting device 1 according to the first embodiment is explained. FIG. 7 is a longitudinal sectional view illustrating the lighting device 1 according to the first embodiment. In FIG. 7, the thermal radiation fins 110 of the thermal radiation module 100 are not illustrated. In FIG. 7, a state in which the fixing member 200 is slid in the vertical direction with respect to the setting surface 101 (a state in which the fixing member 200 moves in the upward direction in FIG. 4) is illustrated. It is assumed that the fixing section 200 is not slid, i.e., rotated in the horizontal direction with respect to the setting surface 101.

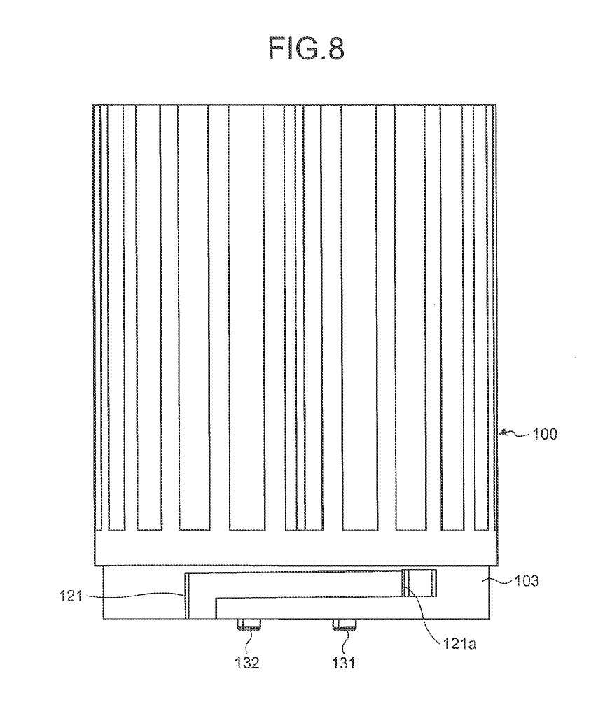

As illustrated in FIG. 7, the light source module 300 comes into contact with the bottom wall 210a of the fixing member 200. If the fixing member 200 is screwed on the thermal radiation module 100, the bottom wall 210a of the fixing member 200 functions as a pressing section configured to press the light source module 300 in a direction toward the thermal radiation module 100. The thermal radiation module 100 is explained with reference to FIG. 8. FIG. 8 is a front view illustrating the thermal radiation module 100 according to the first embodiment.

As illustrated in FIG. 8, the thermal radiation side screwing section 121 of the thermal radiation module 100 is spirally formed to gradually move in the upward direction from the lower end where the fixing member 200 is slid. That is, if the fixing side screwing section 213 of the fixing member 200 slides on the thermal radiation side screwing section 121, the fixing member 200 moves in the direction toward the thermal radiation module 100. Therefore, if the fixing side screwing section 213 slides on the thermal radiation side screwing section 121, the bottom wall 210a of the fixing member 200 illustrated in FIG. 7 moves in the direction toward the setting surface 101 of the thermal radiation module 100 to press the light source module 300 in the direction toward the setting surface 101. As a result, the first surface 301 of the light source module 300 and the setting surface 101 of the thermal radiation module 100 are brought into close surface contact with each other. Therefore, it is possible to efficiently transmit heat generated from the light source module 300 to the thermal radiation module 100. As a result, it is possible to efficiently radiate heat.

Although not explained above, as illustrated in FIG. 7, in the reflecting section 220 of the fixing member 200, an opening section gradually increasing in size further away from the substrate 370 is formed. A luminous intensity distribution direction of the light from the light-emitting element is determined by the shape of the opening section formed in the reflecting section 220.

As explained above, with the lighting device 1 according to the first embodiment, the light source module 300 is inserted into the electrodes 141 and 142, which play a role of sockets, without rotating and is fixed by the fixing member 200. Therefore, with the lighting device 1 according to the first embodiment, the heat conduction sheet stuck to the light source module 300 is not peeled by friction or the like. As a result, it is possible to prevent the thermal radiation effect from being deteriorated. Further, with the lighting device 1 according to the first embodiment, it is possible to detach the fixing member 200 from the thermal radiation module 100 simply by sliding the fixing member 200. Therefore, it is possible to easily replace the fixing member 200 and the light source module 300.

With the lighting device 1 according to the first embodiment, if the fixing member 200 is screwed on the thermal radiation module 100, the fixing member 200 presses the light source module 300 in the direction toward the thermal radiation module 100. Therefore, it is possible to bring the first surface 301 of the light source module 300 and the setting surface 101 of the thermal radiation module 100 into close surface contact with each other and improve the thermal radiation effect.

With the lighting device 1 according to the first embodiment, since the thermal radiation module 100 includes the locking sections 131 and 132 locked to the light source module 300, even if the fixing member 200 is sliding, the light source module 300 does not rotate. Therefore, it is possible to prevent the thermal radiation effect from being deteriorated and prevent the electrodes from being damaged.

### Second Embodiment

The lighting device 1 may be carried out in various different forms other than the first embodiment. In a second embodiment, another form of carrying out the lighting device 1 is explained.

In the first embodiment, as in the example illustrated in FIGS. 2 and 3, one set of the electrodes 141 and 142 is arranged in the symmetrical positions on the setting surface 101. Similarly, one set of the electrodes 311 and 312 is arranged in the symmetrical positions on the first surface 301. However, arrangement positions of the electrodes are not limited to these positions.

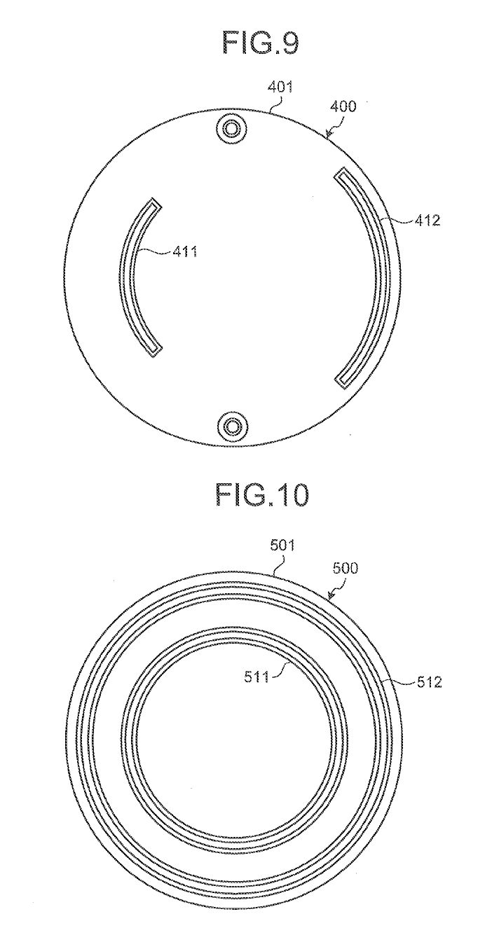

Electrodes according to the second embodiment are explained with reference to FIGS. 9 and 10. FIGS. 9 and 10 are explanatory diagrams for explaining the electrodes according to the second embodiment. In FIG. 9, an example in which a light source module 400 according to the second embodiment is viewed from a first surface 401 (a surface corresponding to the first surface 301 of the light source module 300) is illustrated. In FIG. 10, an example in which a thermal radiation module 500 according to a second embodiment is viewed from a setting surface 501 (a surface corresponding to the setting surface 101 of the thermal radiation module 100) is illustrated.

As illustrated in FIG. 9, in the light source module 400 according to the second embodiment, semiarcuate electrodes 411 and 412 are respectively provided on different concentric circles. Specifically, on the first surface 401 having a substantially circular shape, the semiarcuate electrode 411 is provided on a concentric circle formed by a predetermined radius and the semiarcuate electrode 412 is provided on a concentric circle formed by a radius larger than the predetermined radius. The electrodes 411 and 412 are electrodes on an inserting side of an attachment plug. Like the electrodes 311 and 312 illustrated in FIG. 2 and the like, the electrodes 411 and 412 project from the first surface 401. For example, one electrode 411 of the electrodes 411 and 412 is an anode and the other electrode 412 is a cathode.

As illustrated in FIG. 10, in the thermal radiation module 500 according to the second embodiment, circular electrodes 511 and 512 are respectively provided on different concentric circles. Specifically, on the setting surface 501 having a substantially circular shape, the circular electrode 511 is provided on a concentric circle formed by a predetermined radius and the circular electrode 512 is provided on a concentric circle formed by a radius larger than the predetermined radius. The electrodes 511 and 512 are electrodes on a receiving side of the attachment plug. Like the electrodes 141 and 142 illustrated in FIG. 3 and the like, the electrodes 511 and 512 are formed in a concave shape. For example, one electrode 511 of the electrodes 511 and 512 is an anode and the other electrode 512 is a cathode.

The electrode 411 of the light source module 400 is inserted into the electrode 511 of the thermal radiation module 500. The electrode 412 of the light source module 400 is inserted into the electrode 512 of the thermal radiation module 500. In the case of the examples illustrated in FIGS. 9 and 10, the electrode 411 is not inserted into the electrode 512 and the electrode 412 is not inserted into the electrode 511. That is, in the lighting device 1 according to the second embodiment, it is possible to prevent the electrodes 411 and 412 from being inserted in the wrong electrode 511 or 512 on the receiving side.

In the examples illustrated in FIGS. 9 and 10, as long as the setting surface 401 and the setting surface 501 are substantially parallel and opposed to each other, irrespective of how the light source module 400 is rotated, the electrodes 411 and 412 are inserted into the electrode 511 or 512. Therefore, in the lighting device 1 according to the second embodiment, it is possible to easily attach the light source module 400 to the thermal radiation module 500.

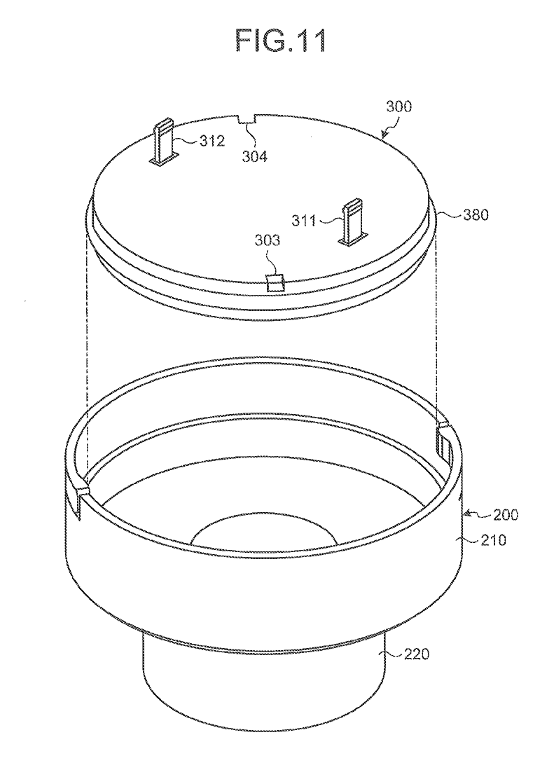

In the first embodiment, in the light source module 300, a ring member 380 set on a side surface of the light source module 300 may be provided. The ring member 380 is explained with reference to FIG. 11. FIG. 11 is an explanatory diagram for explaining the ring member 380 according to the second embodiment.

As illustrated in FIG. 11, the ring member 380 formed by an elastic member or the like is set on the side surface of the light source module 300. The ring member 380 is formed such that, when set in the light source module 300, the ring member 380 has size substantially the same as the opening surface formed by the inner wall of the fixing section 210. Specifically, if the light source module 300 in which the ring member 380 is set is inserted into the fixing section 210, the outer circumferential section of the ring member 380 comes into contact with the inner wall of the fixing section 210.

For example, it is assumed that the fixing member 200 is attached to the thermal radiation module 100 in a state in which the light source module 300 in which the ring member 380 is set is inserted into the fixing section 210. In such a case, since the ring member 380 is in contact with the inner wall of the light source module 300, the light source module 300 rotates together with the fixing member 200. Therefore, since the light source module 300 rotates together with the fixing member 200 until the electrodes 311 and 312 of the light source module 300 are inserted into the electrodes 141 and 142 of the thermal radiation module 100, the operator can easily insert the light source module 300 into the thermal radiation module 100. After the light source module 300 is inserted into the thermal radiation module 100, since the locking sections 131 and 132 of the thermal radiation module 100 are locked to the cutout sections 303 and 304 of the light source module 300, the light source module 300 stops rotating together with the fixing member 200. Therefore, by rotating the fixing member 200, the operator can attach the fixing member 200 to the thermal radiation module 100 without rotating the light source module 300. In this way, since the ring member 380 illustrated in FIG. 11 is set on the side surface of the light source module 300, in the lighting device 1 according to the second embodiment, it is possible to easily insert the light source module 300 into the thermal radiation module 100.

In the first embodiment, the fixing member 200 in which the fixing member 210 and the reflecting section 220 are integrally formed, is explained as an example. However, in the fixing member 200, the fixing section 210 and the reflecting section 220 may be formed detachably attachable.

In the embodiments, the downlight is explained as an example. However, the lighting device 1 can be applied to a lighting device fixture for the ceiling and the like other than the ceiling embedded type as well.

The shapes, the raw materials, and the materials of the members according to the embodiments are not limited to those explained in the embodiments and illustrated in the figures. For example, the substrate 370 illustrated in FIG. 6 may be circular rather than rectangular. For example, the electrodes 411 and 412 illustrated in FIG. 9 may be provided in symmetrical positions on concentric circles on the setting surface 401. In such a case, the electrode 511 and the electrode 512 illustrated in FIG. 10 may be formed in positions opposed to the electrodes 411 and 412 and in a semiarcuate shape like the electrodes 411 and 412.

As explained above, according to the embodiments, it is possible to prevent deterioration in the thermal radiation effect.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lighting device comprising:
a light source module mounted with a light-emitting element;
a thermal radiation member, in which the light source module is set, configured to radiate heat generated from the light source module; and
a fixing member configured to be screwed on a sidewall of the thermal radiation member in a state in which the fixing member surrounds the light source module and the thermal radiation member.

2. The lighting device according to claim 1, wherein
the fixing member includes a pressing section configured to press the light source module in a direction toward the thermal radiation member when the fixing member is screwed on the sidewall of the thermal radiation member.

3. The lighting device according to claim 2, wherein
the fixing member includes a bottom wall as the pressing section and, when the fixing member 200 is screwed on the sidewall of the thermal radiation member, the fixing member adjusts, with a cylindrical reflecting section formed from an opening section of the bottom wall in a direction away from the light source module, a reflecting direction of light emitted by the light-emitting element mounted on the light source module.

4. The lighting device according to claim 1, wherein
the thermal radiation member includes, on a setting surface on which the light source module is set, locking sections locked to the light source module, and
the light source module is set in the thermal radiation member in a state in which the light source module is locked to the locking sections.

5. The lighting device according to claim 4, wherein
the locking sections of the thermal radiation member are formed in a shape projecting from the setting surface, and
in the light source module, cutout sections for locking the locking sections are formed in positions opposed to the locking sections in a surface set on the setting surface of the thermal radiation member.

6. The lighting device according to claim 1, wherein
in the fixing member, slits are formed such that fixing side screwing sections screwed on the sidewall of the thermal radiation member are elastically deformable in an outer side direction and first projecting sections projecting from inner surfaces of the fixing side screwing sections to an inner side are formed, and
in the thermal radiation member, second projecting sections projecting from heat radiation side screwing sections, which form the sidewall, screwed with the fixing side screwing sections to an outer side are formed.

7. The lighting device according to claim 6, wherein
the thermal radiation side screwing sections of the thermal radiation member are formed in a spiral shape for enabling fixing member to move in a direction toward the thermal radiation member.

8. The lighting device according to claim 1, wherein
the light source module includes first electrodes for supplying electric power to the light-emitting element, and
the thermal radiation member includes, in positions opposed to the first electrodes in the setting surface on which the light source module is set, second electrodes that electrically come into contact with the first electrodes.

9. The lighting device according to claim 1, wherein
the first electrodes are a plurality of semiarcuate electrodes respectively provided on different concentric circles on the surface of the light source module set on the setting surface of the thermal radiation member, and
the second electrodes are a plurality of circular electrodes provided in positions opposed to the first electrodes in the setting surface of the thermal radiation member.

10. The lighting device according to claim 1, further comprising:
an elastic member set on a side surface of the light source module and configured to come into contact with an inner wall of the fixing member.
